(19) United States
(12) Patent Application Publication
(10) Pub. No.: US 2003/0043508 A1
(43) Pub. Date: Mar. 6, 2003

(54) Flex on suspension with actuator dynamic function

(76) Inventors: Kevin Jon Schulz, Apple Valley, MN (US); Keefe Michael Russell, Robbinsdale, MN (US); Saoudy Ahmed Saoudy, Eden Prairie, MN (US)

Correspondence Address: John D. Veldhuis-Kroeze, International Centre - Suite 1600, 900 Second Avenue South, Minneapolis, MN, 55402-3319, US

(21) Appl. No.: 10/124,895

(22) Filed: Apr. 17, 2002

Related U.S. Application Data
(60) Provisional application No. 60/317,334, filed on Sep. 5, 2001.

(51) Int. Cl. G11B 5/48

(52) U.S. Cl. 360/245.9; 360/264.2

(57) ABSTRACT

A disc drive comprises an improved electrical interconnect for connecting the head to read/write circuitry on a printed circuit board. A single-cable interconnect has both head suspension capability and dynamic loop function. A pre-amplifier can be connected at either the printed circuit board or mounted on the interconnect. The present invention has improved electrical performance, improved reliability, and lower assembly cost compared to a dual-cable interconnect.

### CROSS-REFERENCE TO RELATED APPLICATION

This application claims priority from U.S. Provisional Application 60/317,334 filed on Sep. 5, 2001 for inventors Kevin Jon Schultz, Keefe Michael Russell, and Saoudy Ahmed Saoudy and entitled Flex On Suspension with Actuator Dynamic Function.

### FIELD OF THE INVENTION

The present invention relates generally to disc drives, and more particularly but not by limitation to an electrical interconnect for electrically connecting a data head to read/write circuitry in a disc drive.

### BACKGROUND OF THE INVENTION

The present invention relates to disc drives such as magnetic disc drives, optical disc drives, and/or magneto-optical disc drives. In particular, the present invention relates to an electrical interconnect for electrically connecting a data head to read/write circuitry in a disc drive.

Data heads, such as magnetic heads, require an electrical interconnect between transducers that are mounted on the head and read/write circuitry typically located on a printed circuit board (PCB). Typically, this electrical interconnect includes two flexible circuit assemblies, one commonly known as a flex on suspension (FOS) cable and the other a printed circuit cable assembly (PCCA) cable. The FOS cable functions both as an electrical interconnect and actuator suspension, especially head suspension. The PCCA cable includes a flexible circuit that provides a dynamic loop for low resistance pivoting of the actuator assembly and a connector for connecting to the PCB.

Prior art FOS cables are generally described in several Seagate Technology Inc. patents, U.S. Pat. Nos. 5,701,218 and 5,796,556 to Boutaghou; U.S. Pat. No. 5,883,759 to Schultz; U.S. Pat. No. 5,946,163 to Boutaghou et al.; and U.S. Pat. Nos. 6,021,022 and 6,046,886 to Himes et al.

Typically, the FOS cable extends from the transducers down the suspension and actuator arm and then electrically interconnects to the PCCA cable. The FOS/PCCA connection typically occurs on the side of the actuator assembly. The PCCA cable typically extends away from the actuator pivot assembly, forms the dynamic loop, feeds through the disc housing, and electrically connects to the PCB which contains read/write circuitry. A pre-amplifier is typically mounted on the actuator assembly at or near the FOS/PCCA connection in order to amplify the signals from the data head. This can be necessary because of signal loss at the FOS/PCCA connection.

The two-cable FOS/PCCA interconnect between the head and read/write circuitry on the PCB typically necessitates a solder or ultrasonic bonding connection on the side of the actuator pivot assembly. This connection results in higher labor costs and reliability problems. Also, the FOS/PCCA interconnect results in some signal loss due to impedance discontinuities at the juncture between the two cables. Further signal loss results from the relatively high impedance of the PCCA cable.

An electrical interconnect which overcomes one or more of these or other problems, and/or which offers other advantages over the prior art, would be a significant improvement.

### SUMMARY OF THE INVENTION

The present invention is an improved electrical interconnect for connecting the data head to read/write circuitry. The interconnect combines the suspension function of an FOS cable with the dynamic loop function of a PCCA cable into a single cable that performs both functions. The single cable has approximately uniform impedance along its length, and may be impedance matched at the head, and may be terminated with an impedance matched connector adapted to connect with the PCB. The present invention can provide one or more of improved electrical performance, improved reliability, and lower assembly cost compared to prior art interconnects.

Other features and benefits that characterize embodiments of the present invention will be apparent upon reading the following detailed description and review of the associated drawings.

### BRIEF DESCRIPTION OF THE DRAWINGS

FIG. 1 is an isometric view of a prior art disc drive.

FIG. 2 is a diagrammatic plan view of a disc drive with a single-cable interconnect.

FIG. 3 is a diagrammatic perspective view of a single-cable interconnect.

FIG. 4 is a diagrammatic assembly view of a prior art dual-cable interconnect with conductive traces.

FIG. 5 is a diagrammatic assembly view of a single cable interconnect with conductive traces.

FIG. 6 is a diagrammatic cross-section of a single cable interconnect with conductive traces.

### DETAILED DESCRIPTION OF ILLUSTRATIVE EMBODIMENTS

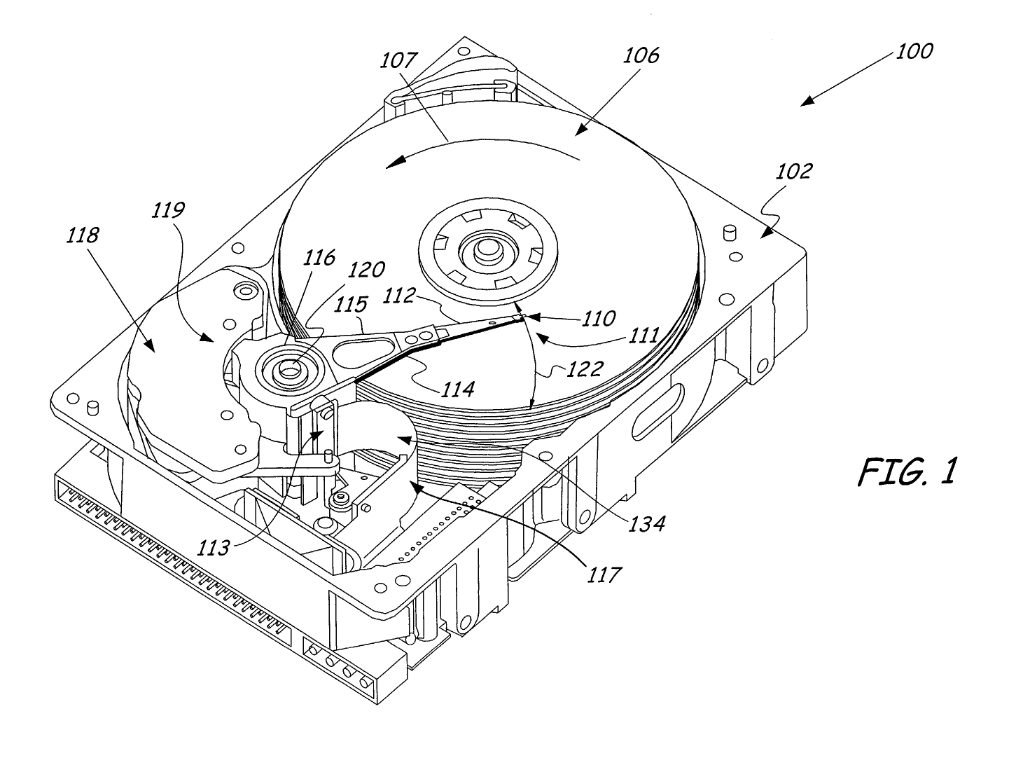

FIG. 1 is an isometric view of a prior art disc drive useful in illustrating embodiments of the present invention. Disc drive 100 can be, for example, a magnetic disc drive, an optical disc drive, or a magneto-optical disc drive. Disc drive 100 includes a housing with a base 102 and a top cover (not shown). Disc drive 100 includes a disc pack 106, which is mounted on a spindle motor 127. The spindle motor 127 drives rotation of the disc pack 106. The disc pack 106 includes a plurality of individual discs that are mounted for co-rotation in a direction indicated by arrow 107.

Each individual disc is accessible by a read/write assembly 111 including a read/write head 110, transducer (not shown), and suspension 112. As the disc pack 106 rotates, the read/write assembly 111 is actuated by an actuator assembly 119. The actuator assembly 119 shown in FIG. 1 is of the type known as a rotary moving coil actuator. The actuator assembly 119 includes a voice coil motor (VCM) 118, a rotor 116, and an actuator arm 115. The VCM 118 rotates the rotor 116 and attached arm 115 supporting read/write assembly 111. The rotor 116 rotates about shaft 120 to position read/write head 110 over a desired data track along an arcuate path 122.

Disc drive 100 includes a printed circuit board (not shown) with control circuitry. The control circuitry comprises motor circuitry for energizing the spindle motor 127 and the VCM 118. The control circuitry further comprises read/write circuitry for transferring data in and out of the disc drive 100. The read/write circuitry typically includes a pre-amplifier (not shown) which may be mounted on the PCB, or alternately, on the side of actuator assembly 119.

An FOS cable 114 electrically connects at the transducers on head 110 and extends along actuator arm 115 to the actuator assembly 119. The FOS cable 114 provides at least a portion of the suspension 112. At the side of the actuator assembly 119, the FOS cable 114 and a PCCA cable 117 form an electrical connection 113, typically through the use of bonding pads (not shown). The PCCA cable 117 extends outward from the actuator assembly 119 and electrically connects with the PCB containing read/write circuitry. The PCCA cable 117 includes dynamic loop 134 that allows low resistance pivoting of actuator assembly 119.

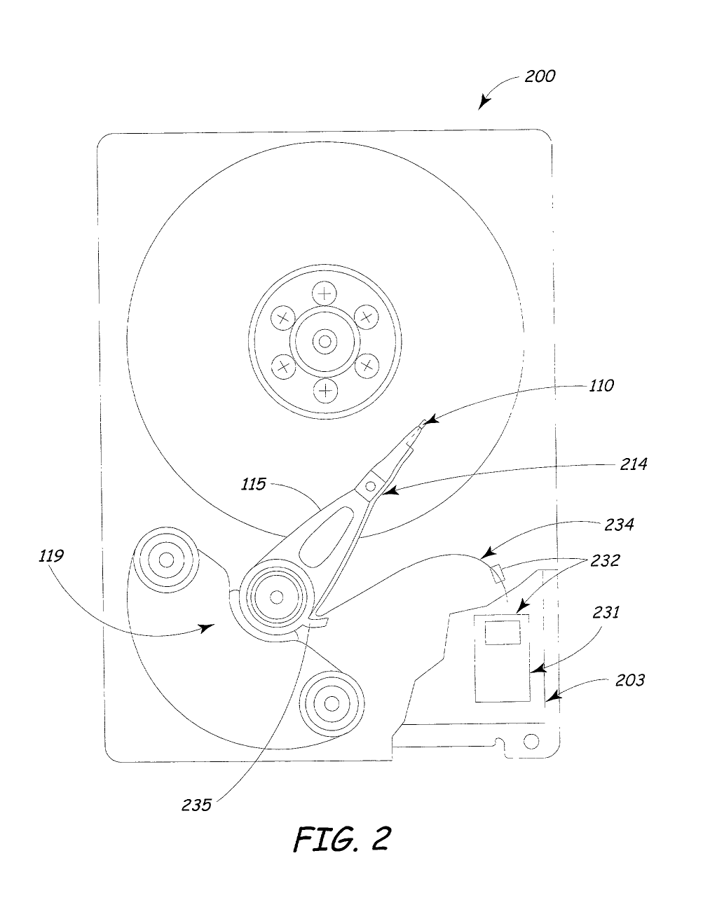

FIG. 2 illustrates a diagrammatic plan view of an embodiment of the present invention showing a disc drive 200 with a single-cable interconnect 214 extending from a head 110 to a printed circuit board 203 which contains read/write circuitry shown diagrammatically at 231. The single-cable interconnect 214 combines the suspension function of an FOS cable with the dynamic loop function of a PCCA cable. The single-cable interconnect extends along length of arm 115, changes direction at a support 235 mounted on actuator assembly 119, forms a dynamic loop 234, and electrically connects to the read/write circuitry 231. In the illustrated embodiment, read/write circuitry 231 can include preamplifier 232, as opposed to the preamplifier being positioned near an interconnect between separate FOS and PCCA cables. The dynamic loop 234 in the interconnect 214 permits low resistance pivoting of arm 115. As mentioned, the preamplifier 232 can generally be considered a part of read/write circuitry 231. However, two alternate placements for the pre-amplifier 232 are shown, because the pre-amplifier 232 may alternately be mounted the interconnect 214.

In some embodiments, an advantage of the single-cable interconnect includes decreased signal loss. In the prior art disc drive, there can be a certain amount of signal reflection due to impedance discontinuity at the juncture between the separate FOS and PCCA cables. Using a single-cable interconnect permits uniform controlled impedance along the length of the interconnect resulting in less reflection or signal loss.

In some embodiments another advantage can be cost savings from reduced assembly cost. This cost savings can potentially be realized because the single-cable interconnect eliminates the need for labor-intensive soldering or ultrasonic bonding at the juncture between the FOS and PCCA cables. A third advantage which may be realized in some embodiments is that the single-cable interconnect results in greater reliability. The two-cable interconnect is inherently less reliable due to the inexactness of individually soldering or bonding copper traces at the juncture of two cables.

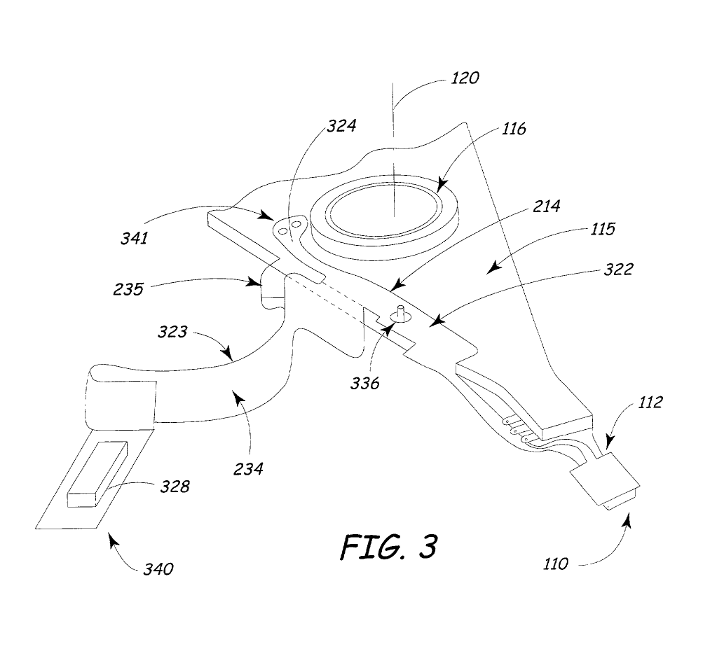

FIG. 3 is a diagrammatic perspective view of an embodiment of the present invention showing a single-cable interconnect 214 extending from head 110 along arm 115 to a connector 340 adapted for connecting to the PCB (shown in FIG. 2). The interconnect 214 optionally may be impedance matched to the head 110, and the connector 340 and preamplifier 232 (shown in FIG.2) optionally may be impedance matched to the interconnect 214.

The interconnect 214 has multiple portions. First, an FOS portion 322 performs functions of both an electrical interconnect and a suspension for head 110 in a manner similar to (or the same as) prior art FOS interconnects. The FOS portion electrically connects to one or more transducers (not shown) formed on head 110. The FOS portion 322 extends from the head 110 along arm 115 towards rotor 116 (about which arm 115 pivots). The FOS portion is secured to arm 115 by a first support 336, which can be a solder pin, for example.

Second, a PCCA portion 323 provides both electrical interconnect and dynamic loop functions. The PCCA portion 323 extends from the FOS portion 322 and further extends outward from arm 115 to a connector 340 adapted for electrical connection to the PCB 203 (shown in FIG. 2). The PCCA portion 323 includes dynamic loop 234 that allows low resistance pivoting of arm 115. A second support 235 helps support and position the PCCA portion 323, as well as assists in changing direction of portion 323 of interconnect 214.

Third, an optional a voice coil motor (VCM) portion 324 extends from the FOS portion 322 and continues along the arm 115 in the direction of the VCM (not shown). The VCM portion 324 includes an end 341 adapted to electrically couple to the VCM. Thus, the single cable interconnect provides FOS and PCCA functions, as well as optionally carrying electrical signals to the VCM.

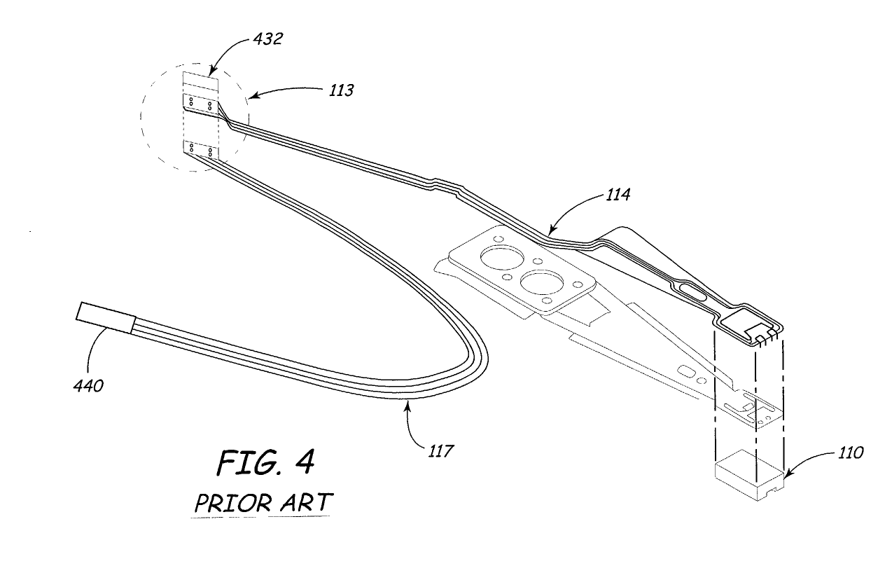

FIG. 4 is a diagrammatic assembly drawing of a prior art dual-cable interconnect showing conductive traces, typically comprising copper, but other metals can be used. An insulating substrate such as polyamide is typically used in both the prior art and the present invention. An FOS cable 114 electrically connects to the head 110, extends down the arm (not shown), and terminates at an electrical connection 113 on the actuator pivot assembly (not shown). At the electrical connection 113, a PCCA cable 117 is electrically connected with the FOS cable 114 by means such as soldering or ultrasonic bonding. A pre-amplifier 432 is typically connected at or near the juncture of the two cables. FIG. 4 further illustrates the head suspension and electrical connection functions of the FOS cable and was previously described at least in U.S. Pat. No. 5,883,759 to Schultz.

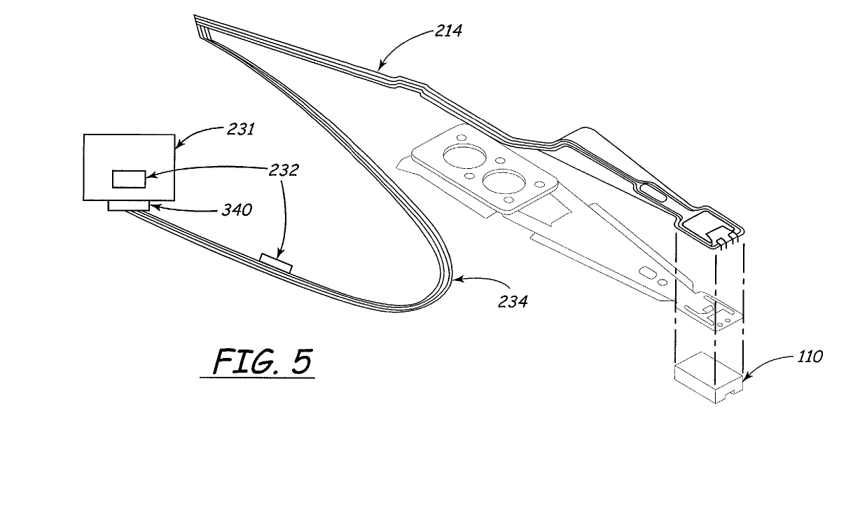

FIG. 5 illustrates a diagrammatic view of a single-cable interconnect with conductive traces, typically copper or other metal. A single FOS cable 214 electrically connects to the head 110, extends down the actuator arm 115 (shown in FIGS. 2 and 3), changes direction at a support 235 (shown in FIGS. 2 and 3), forms dynamic loop 234, and terminates with a connector 340 that is adapted for mounting on a PCB 231. A preamplifier 232 may be mounted on the PCB 231, or alternately, on the cable 214. It can be desirable in some embodiments that the impedance of the head 110, interconnect 214, preamplifier 232, and connector 340 are matched to reduce signal reflection.

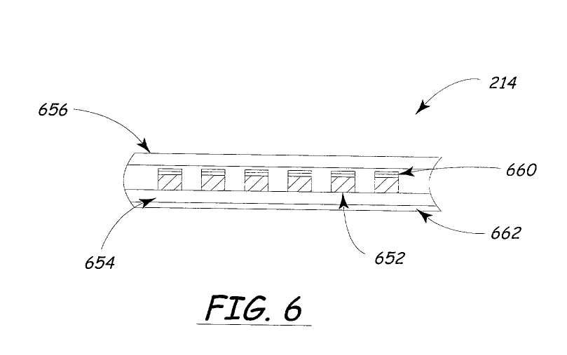

FIG. 6 illustrates a diagrammatic cross-sectional view of a flexible interconnect made using processes of the type which are similar to those known in the art with an exception being that prior art processes did not result in a single interconnect 214 as described above. A flexible circuit 214 comprises a flexible and electrically insulating substrate 654 supporting electrical traces 652. An embodiment of the present invention may have a polyimide/copper structure for substrate 654 and electrical traces 652, respectively, with a top electrically insulating layer 656 which is also made from a flexible material such as polyimide. The interconnect 214 may comprise a photo-imaginable covercoat portion 660 in critically aligned regions and/or a laminated coverfilm portion (not shown) in the dynamic region to provide balanced stress in the electrical traces during flexing. To increase interconnect conductivity, a trace metallic layer 662, approximately 0.1 microns thick, may be deposed on the bottom of the interconnect substrate 654.

The present embodiment allows a single FOS cable to perform its electrical interconnect and suspension function, as well as the PCCA cable's typical dynamic loop function. Advantages of the present embodiment include eliminating an electrical connection on the actuator assembly. This electrical connection is shown in FIG. 1 and FIG. 4 as 113. Eliminating electrical connection 113 is advantageous because there is less signal loss due to signal reflection from cables having differing impedance. A single cable results in uniform impedance along the cable. Eliminating the connection 113 also improves reliability of the interconnect. The connection 113 makes the interconnect less reliable due to the inherent non-uniformity of the connection 113, typically accomplished by hand soldering or bonding. The present embodiment also reduces labor cost because the hand soldering is a labor-intensive process.

In summary, the present invention includes an embodiment of a disc drive data storage system (200) comprising a data storage disc (106) providing a recording surface; a data head (110); an actuator assembly (119) having an actuator arm (115), the actuator arm (115) supporting the data head (110) proximate the recording surface; and a flex on suspension flexible circuit (214) having a first end electrically coupled to the data head (110). The flex on suspension flexible circuit extends from the data head (110) along the actuator arm (115). The flex on suspension flexible circuit further extends away from the actuator arm (115), and provides a dynamic loop (234) which allows low resistance pivoting of the actuator assembly (119).

It is understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the disc drive while maintaining substantially the same functionality without departing from the scope and spirit of the present invention.

In addition, although the preferred embodiment described herein is directed to a flex on suspension with actuator dynamic function interconnect system for a disc drive, it will be appreciated by those skilled in the art that the teachings of the present invention can be applied to a disc drive single-cable interconnect, without departing from the scope and spirit of the present invention.

What is claimed is:

1. A disc drive data storage system, comprising:
a data storage disc providing a recording surface;
a data head;
an actuator assembly having an actuator arm, the actuator arm supporting the data head proximate the recording surface; and
a flex on suspension flexible circuit having a first end electrically coupled to the data head, the flex on suspension flexible circuit extending from the data head along the actuator arm, the flex on suspension flexible circuit further extending away from the actuator arm and providing a dynamic loop which allows low resistance pivoting of the actuator assembly.

2. The disc drive data storage system of claim 1, wherein the flex on suspension flexible circuit forms at least a portion of a suspension supporting the data head.

3. The disc drive data storage system of claim 2, further comprising a connector electrically coupled to a second end of the flex on suspension flexible circuit, the dynamic loop being formed between the actuator arm and the second end of the flex on suspension flexible circuit.

4. The disc drive data storage system of claim 3, further comprising a printed circuit board, wherein the connector connects to the printed circuit board.

5. The disc drive data storage system of claim 4, wherein the connector has impedance substantially matched to the second end of the flex on suspension flexible circuit.

6. The disc drive data storage system of claim 5, further comprising a pre-amplifier electrically coupled to the flex on suspension flexible circuit.

7. The disc drive data storage system of claim 1, wherein the flex on suspension flexible circuit further comprises:
a substrate that is flexible and electrically insulating; and
a first conducting layer overlaying the substrate and forming a plurality of conductive traces in the first conducting layer.

8. The disc drive data storage system of claim 7, further comprising a first insulating layer overlaying the first conducting layer.

9. The disc drive data storage system of claim 8 further comprising a photo-imageable covercoat portion.

10. The disc drive data storage system of claim 7, wherein the substrate comprises polyimide and the first conducting layer comprises copper.

11. The disc drive data storage system of claim 7, further comprising:
a trace metallic layer approximately 0.1 microns thick disposed on at least one portion of the flexible cable.

12. A flex on suspension flexible circuit for use in a disc drive data storage system having a data head and an actuator assembly, the flex on suspension flexible circuit comprising:
a first end configured for electrically coupling to the data head;
a second end; and
a dynamic loop which provides low resistance pivoting of the actuator assembly when the flex on suspension flexible circuit is used with the disc drive data storage system, wherein the flexible circuit is continuous and extends from the first end through the dynamic loop to the second end.

13. The flex on suspension flexible circuit of claim 12, wherein the flexible circuit forms at least a portion of a suspension for the data head.

14. The flex on suspension flexible circuit of claim 12, further comprising a connector electrically coupled to the second end.

15. The flex on suspension flexible circuit of claim 13 wherein the connector is impedance matched to the second end.

16. The flex on suspension flexible circuit in claim 12 further comprising:
a substrate that is flexible and electrically insulating;
a first conducting layer overlaying the substrate, a plurality of conductive data lines formed in the first conducting layer.

17. The flex on suspension flexible circuit of claim 16, further comprising a first insulating layer overlaying the first conducting layer.

18. A disc drive data storage system, comprising:
a data storage disc providing a recording surface;
a data head;
an actuator assembly having an actuator arm, the actuator arm supporting the data head proximate the recording surface; and
means for electrically coupling the data head to read/write circuitry while providing low resistance pivoting of the actuator assembly.

19. The disc drive data storage system of claim 18, wherein the means for electrically coupling forms at least a portion of a suspension supporting the data head.

20. The disc drive data storage system of claim 19, wherein the means for electrically coupling includes a dynamic loop which allows the low resistance pivoting of the actuator assembly.
